(19) United States
(12) Patent Application Publication
(10) Pub. No.: US 2006/0031936 A1
(43) Pub. Date: Feb. 9, 2006

(54) Encryption security in a network system

(75) Inventors: David B. Nelson, Derry, NH (US); Richard W. Graham, Derry, NH (US)

Correspondence Address: CHRIS A. CASEIRO, VERRILL DANA, LLP, ONE PORTLAND SQUARE, PORTLAND, ME, 04112-0586, US

(73) Assignee: Enterasys Networks, Inc., Andover, MA (US)

(21) Appl. No.: 10/971,905

(22) Filed: Oct. 22, 2004

Related U.S. Application Data
(63) Continuation-in-part of application No. 10/116,447, filed on Apr. 4, 2002.

(51) Int. Cl. G06F 12/14

(52) U.S. Cl. 726/23

(57) ABSTRACT

A system and method for enhancing the security of signal exchanges in a network system. The system and method include a process and means for generating one or more replacement encryption key sets based on information and events. The information that may cause the generation of a replacement encryption key set includes, but is not limited to, a specified period of time, the level and/or type of signal traffic, and the signal transmission protocol and the amount of data sent. A key manager function initiates the replacement encryption key process based on the information. The replacement encryption key set may be randomly or pseudo-randomly generated. Functions attached to the network system required to employ encryption key sets may have encryption key sets unique to them or shared with one or more other attached functions. The system and method may be employed in a wireless, wired, or mixed transmission medium environment.

### CROSS REFERENCE TO RELATED APPLICATION

This application is a continuation-in-part of co-pending U.S. patent application Ser. No. 10/116,447, filed Apr. 4, 2002, entitled UA SYSTEM AND METHOD TO PROVIDE ENHANCED SECURITY IN A WIRELESS LOCAL AREA NETWORK SYSTEM owned by a common assignee. The content of that application is incorporated herein by reference and priority is claimed therein.

### BACKGROUND OF THE INVENTION

1. Field of the Invention

The present invention relates to systems and methods for enhancing the security of signal exchanges in network systems. More particularly, the present invention relates to systems and methods for encrypting such exchanges.

2. Description of the Prior Art

Interconnected computing systems form the basis of a network. A network permits communication or signal exchange among computing systems of a common group in some selectable way. The interconnection of those computing systems, as well as the devices that regulate and facilitate the exchange among the systems, represent a network. Further, networks may be interconnected together to establish internetworks. For purposes of the description of the present invention, the devices and functions that establish the interconnection represent the network infrastructure. The users, computing devices and the like that use that network infrastructure to communicate are referred to herein as attached functions and will be further defined. The combination of the attached functions and the network infrastructure will be referred to as a network system.

Presently, access to applications, files, databases, programs, and other capabilities associated with the entirety of a discrete network is restricted primarily based on the identity of the user and/or the network attached function. For the purpose of the description of the present invention, a “user” is a human being who interfaces via a computing device with the services associated with a network. For purposes of further clarity, a “network attached function” or an “attached function” may be a user connected to the network through a computing device and a network interface device, an attached device connected to the network, a function using the services of or providing services to the network, or an application associated with an attached device. Upon authentication or other form of confirmation of the offered attached function identity, the attached function may access network services at the level permitted for that identification. For purposes of the present description, “network services” include, but are not limited to, access, data transport service, Quality of Service (QoS) capabilities, bandwidth, priority, computer programs, applications, databases, files, and network and server control systems that attached functions may use, communicate across or with manipulate for the purpose of conducting the business of the enterprise employing the network as an asset.

A network session is the establishment of an association between an attached function and one or more network services through the network infrastructure. It is to be understood, however, that a network system may be embodied in the combination or interrelation between one or more attached functions and one or more network infrastructure devices. At the outset of a network session, often in relation to the authentication of the entity requesting the session, an association is created between the attached function and/or one or more network infrastructure devices and one or more network services, constrained by one or more policies enforced based on policy enforcement rules carried out by one or more devices of the network infrastructure.

The process by which the various computing systems of a network or internetwork communicate is regulated by agreed-upon signal exchange standards and protocols embodied in network devices, interface cards, circuitry and software. Such standards and protocols were borne out of the need and desire to provide interoperability among the array of computing systems available from a plurality of suppliers. Two organizations that have been substantially responsible for signal exchange standardization are the Institute of Electrical and Electronic Engineers (IEEE) and the Internet Engineering Task Force (IETF). In particular, the IEEE standards for internetwork operability have been established, or are in the process of being established, under the purview of the 802 committee on Local Area Networks (LANs) and Metropolitan Area Networks (MANs).

Among others, the IETF has established a protocol to secure signal transmissions at Layer 4 of the Open Systems Interconnection (OSI). The Transport Layer Security (TLS) protocol defined by the IETF is based upon the Secure Sockets Layer (SSL) protocol and involves the encryption of transport layer transmissions based on a public key-private key exchange. Specifically, an end user contacts a service provider to gain access to the Internet. The answering server sends a public key to the user's browser that in turn generates a random private key that is employed for the remainder of the secured Internet session. A break in the signal exchange between the server and the browser requires re-initialization of the TLS protocol.

In another example of a standardized technique to enhance network session security, IEEE standard 802.1X is designed to improve network security. It establishes a framework for network authentication of a user seeking to connect to a particular network and access programs associated with that network, and for distribution of encryption keys for use at Layer 2 of the OSI. When a user initiates connection to the network through a network system device, the device, such as a switch, a router, or a wireless access point, for example, initially only forwards user request information, including identity information pursuant to an authentication protocol, such as the Extensible Authentication Protocol (EAP), to network management. All other communication activities are blocked during the authentication process. An authentication server of the network then resolves the user's network access permissions, if any, and forwards an accept/reject message to the network access device. The network access device then either authorizes access or it blocks access for the requesting user. IEEE standard 802.1X is applicable to wired and wireless network connections.

IEEE standard 802.11 is directed to wireless LAN (WLAN) standards and Layer 2 of the OSI in particular. The standard establishes a framework for the bands of radio signal propagation to enable bit transmission rates substantially compatible with existing expectations of network signal exchange rates. Whereas 802.1X defines network access authentication regardless of signal transmission medium, 802.11 is specifically directed to transmission standards in a wireless environment. Neither specifically addresses the security of signal exchanges in a wired or wireless environment once network access has been established.

An IETF-based method for securing signal exchanges across otherwise unsecured public network systems—such as the internet—is the Virtual Private Network (VPN). A VPN is a network arrangement constructed from both public and private devices. Such interconnection are generally established by enterprises having separated offices or locations that must be interconnected across public infrastructures. A VPN permits the sharing of private information across the public infrastructure through the encryption of the signal exchanges. The encryption methodology is standardized to produce what is generally referred to as a tunnel. That is, the encryption creates a what is intended to be a hardened tunnel through which the VPN signal exchanges pass encased by the standardized signal exchange protocols associated with the public infrastructure.

Currently, there are four different protocols generally employed in the creation of these VPN tunnels. They are Point-to-Point Tunneling Protocol (PPTP), Layer-2 Forwarding (L2F), Layer-2 Tunneling Protocol (L2TP), and Internet Protocol Security Protocol (IPSec). IPSec tends to be directed to LAN-to-LAN exchanges while the other protocols tend to be employed for dial-up exchanges. IPSec employs encryption keys to secure data and/or packet headers. Public/private encryption keys are exchanged between communicating devices through the Internet Key Exchange (IKE) standard. At the start of a network session, the keys are exchanged to establish the tunnel. The same keys are used throughout the course of the session to encrypt the signals exchanged. Unfortunately, with sufficient time, signal exchange volume, applied computing power and/or because of flaws in the encryption algorithms or implementations, it has been determined that the encrypted signals can be compromised.

It is known that wireless communications may be more susceptible to interception than signal transmissions on wired or fiber media. Nevertheless, signal transmissions in wired or fiber environments may also be susceptible to interception. Intercepted signals may be used for unauthorized gathering of information as well as unauthorized access to the network. As a result of those concerns, wireless network communications, like VPN communications, are preferably encrypted. It is widely believed that the encryption of a wireless transmission equates to the security associated with a wired network for which physical security mechanisms are possible.

The Wired Equivalent Privacy (WEP) algorithm provides under IEEE 802.11 the standardized wireless encryption method. WEP involves the use of a secret or private key that is shared among one or more mobile computer systems and an access point that is wired to a network. The key, a string of bits, is combined with readable data in a defined mathematically determined manner to generate ciphered data. In particular, WEP uses the RC4 algorithm to generate a pseudo-random key stream that is combined with the data to generate encrypted data packets. The receiver, having the same key and algorithm, simply performs the inverse same mathematical function on the cipher stream to reproduce the readable data. In order to avoid duplicative ciphering, which aids crypto analysis, WEP further employs an initialization vector (IV), or public key, added to the secret key, prior to ciphering, to minimize re-use of the same effective cipher key. The IV is currently a 24-bit field that transmits in clear text. With sufficient traffic on the WLAN, the IV and corresponding private portion of the WEP key can be detected by crypto analysis, decrypted, and the network and its traffic exposed and subject to compromise.

Therefore, what is needed is an improved system and method for securing signal exchanges in wired and wireless network environments. Further, what is needed is such a system and method that increases the difficulty of compromising the encryption of signal exchanges throughout a network session.

### SUMMARY OF THE INVENTION

It is an object of the present invention to enhance the security of a network session through the generation of one or more replacement encryption keys and using such one or more replacement encryption keys to replace one or more existing keys during the network session. It is also an object of the invention to enable the enhancement to be employed in a wired or a wireless exchange, provided the encryption complies with existing exchange protocols including, but not limited to, wired LAN, MAN and WAN and wireless standards. These and other objects are met by providing the improved security at the point where an attached function and a network infrastructure device exchange signals, where two or more network infrastructure devices exchange signals, or where two attached functions exchange signals. In particular, one or more replacement encryption keys are generated and, during the course of the network session, the one or more replacement keys are used to replace one or more of the existing keys used to encrypt the signal exchanges of the session.

The present invention includes a method for enhancing the security of a network including one or more network infrastructure devices capable of exchanging messages. The method includes the steps of generating a plurality of encryption keys, encrypting some or all of the messages between two or more of the network infrastructure devices, or within one or more of the network infrastructure devices capable of exchanging messages across functions within the device, with one or more of the plurality of encryption keys, and in the course of the message exchanges, replacing one or more of the one or more encryption keys with one or more replacement encryption keys. In one alternative embodiment of the invention, the steps performed include generating a plurality of encryption keys for use in encrypting message exchanges between the one or more attached functions and the network, using the plurality of encryption keys in the message exchanges between the one or more network access devices and the one or more attached functions, generating one or more replacement encryption keys, and during the session, replacing one or more of the plurality of encryption keys with the one or more replacement encryption keys at non-regular intervals. In another alternative embodiment of the invention, the method includes the steps of generating a plurality of encryption keys for use in encrypting messages between the one or more network access devices and one or more attached functions, encrypting some or all of the messages with one or more of the plurality of encryption keys, and in the course of exchanging messages with the one or more attached functions, without authenticating, transmitting to the one or more attached functions one or more replacement encryption keys to replace one or more of the one or more encryption keys. The plurality of encryption keys and the one or more replacement encryption keys may be randomly generated. Optionally, at least one of the one or more network access devices generates and transmits the plurality of encryption keys and the one or more replacement encryption keys.

In one form of the invention, at least two of the plurality of encryption keys is unique to each device or attached function including the encryption function. In another form of the invention, at least one of the plurality of encryption keys is shared among all encryption functions. The plurality of encryption keys may be replaced as a function of the number of encrypted messages, as a function of the amount of information exchanged during the session, or they may be replaced randomly. The method of the invention further includes the option of replacing one or more of the one or more replacement encryption keys during the session, and repeating that step as desired. The basis for generating and distributing replacement encryption keys may be different from one replacement cycle to another. In a form of the invention, a first one of the plurality of encryption keys is designated a transmit key and a second one of the plurality of encryption keys is designated a receive key.

In order to effect efficient replacement of one or more existing keys with one or more generated replacement keys, at least one of the plurality of encryption keys may be designated for multicast transmissions and/or broadcast transmissions. Further, one or more of the encryption keys may be associated with a transmission protocol or a set of transmission protocols. Optionally, at least one of the plurality of encryption keys may be retained rather than replaced when others of the plurality of encryption keys are replaced. The retained encryption key or keys may be replaced with a second set of replacement encryption keys, wherein at least one of the second set of replacement encryption keys is a second retained encryption key that is not replaced when the one or more replacement encryption keys is replaced. The network device used to generate and transmit one or more replacement keys, or to transmit one or more replacement keys generated by another network system device may be a wireless access point, a local area network router, a wide area network router, a VPN appliance, or a switch, but is not limited thereto. The transmission of the one or more replacement keys may take place over a wired, including optical cabling, a wireless transmission medium, or a combination of the two.

The present invention is effective in the context of existing standards-based networks in that it contemplates the initial security features associated with initial access to the network by an attached function. For example, preliminary network authentication communication security keys may first be used to authenticate the attached function to the network. Thereafter, the replacement key generation process enhances the security of the ongoing network session by replacing originally provided keys in a manner that may be random and that may be done as specified conditions are met. That is, key replacement may be programmed as a function of specified conditions including, for example, network perceived threat level, location of device or transmission apparatus and cabling or aggregation of signals, preferably ahead of any then-existing crypto analysis attack capabilities. It is anticipated that an event which might cause a more rapid timing of the changing on the keys would be the advancement or discovery of hacker techniques or capabilities to more quickly decipher the data stream. The invention also uses the changing of the keys to improve capabilities of systems with time, performance and cost tradeoffs which implement less robust encryption techniques. Its use is expected to improve security for VPN and tunneling implementations and configurations where the tunnel may provide a secure transport but users of the system may not be authenticated. Initial authentication of devices may also be done manually or in some administration or trusted user defined method.

The details of one or more examples related to the invention are set forth in the accompanying drawings and the description below. Other features, objects, and advantages of the invention will be apparent from the description and drawings, and from any appended claims.

### BRIEF DESCRIPTION OF THE DRAWINGS

FIG. 1 is a simplified diagrammatic block representation of an example network system with the enhanced security system of the present invention.

FIG. 2 is a simplified block representation of a network infrastructure device including the replacement encryption key generator of the present invention.

FIG. 3 is a simplified block representation of a key manager function of the present invention.

FIG. 4 is a flow diagram of a first embodiment of the process of the present invention for enhancing network system security.

FIG. 5 is a flow diagram of a second embodiment of the process of the present invention for enhancing network system security.

### DETAILED DESCRIPTION OF THE PREFERRED EMBODIMENT OF THE INVENTION

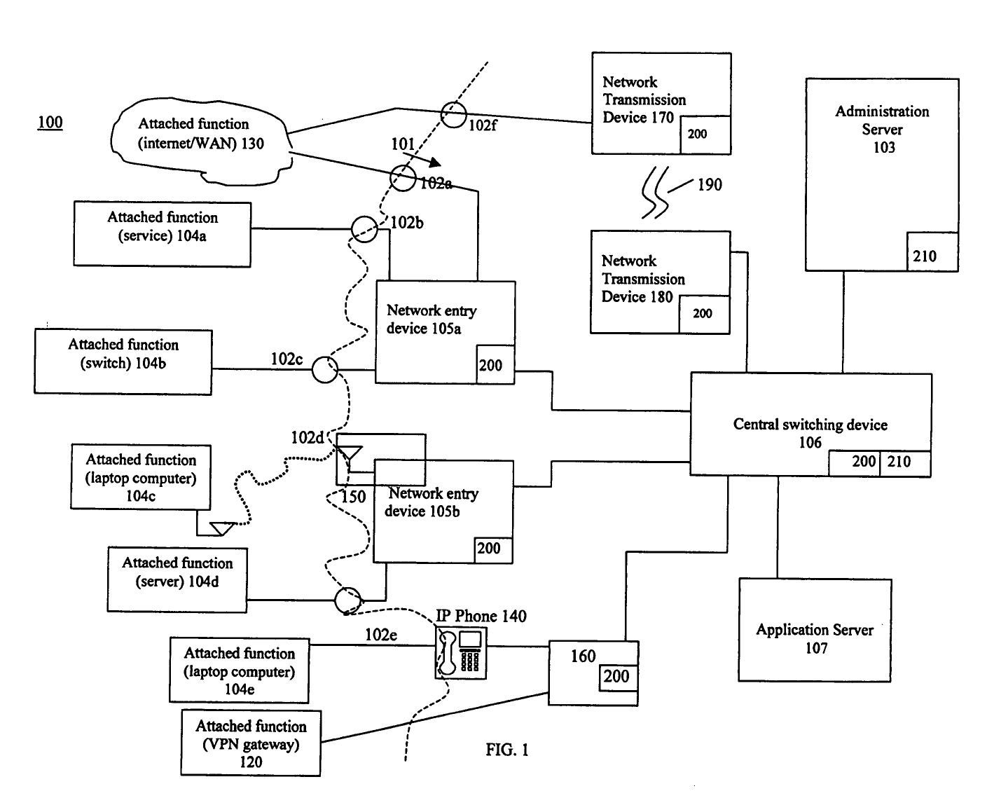

The present invention is a system and related method to enhance the security of a network system through the replacement of one or more encryption keys in the course of a network session. Referring to FIG. 1, a representation of a network system 100 incorporating the capability of the enhanced security system of the present invention operates and provides network services to attached functions according to policies and policy enforcement rules to devices of a network infrastructure 101 through which the attached functions access and use services of the network system 100. Network system 100 includes the network infrastructure 101 and one or more attached functions connected to or connectable to the network infrastructure 101. The network infrastructure 101 includes multiple switching devices, routing devices, firewalls, Intrusion Detection Systems, wired and wireless access points, Metropolitan Area Networks (MANs), WANs, VPN appliances, and internet connectivity interconnected to one another and connectable to the attached functions by way of connection points (e.g., 102a-f). The network infrastructure 101 includes such devices having forwarding functionality for the purpose of accessing and using network services.

The network infrastructure 101 may also include network transmission devices, shown in FIG. 1 and identified herein as devices 170 and 180. The network transmission devices 170 and 180 may be bridge devices that enable signal exchange at selectable layers of the OSI model at relatively high throughput. Device 170 is shown as a link between an external attached function, in this case the internet, and device 180. Device 180 is shown as connected to central switching device 106. It is to be understood that other sorts of transmission devices with other types of connections within and outside of the network infrastructure 101 may be embodied in the network system 100 and may be suitable for the encryption system of the present invention. Either or both of network transmission devices 170 and 180 may be wireless transmit/receive devices for signal exchanges across open spaces that may be susceptible to signal interception, such as between buildings of a campus. Such devices may not be protectable by current VPN security means. The present invention provides a means for establishing a secure exchange link 190 for these wireless exchanges. It is to be noted that such exchanges are ordinarily not subject to attached function authentication and are better thought of as part of the infrastructure links which are expected to have higher security and privacy than cleartext protocols on laser, infrared, RF or other open or assessable links, including some wired links. It is to be noted that the link 190 may also be a wire link spanning a location that may not be sufficiently secured from physical intrusion efforts.

A security enhancement system of the present invention includes a replacement encryption key generator 200 and a replacement key manager function 210. The replacement encryption key generator 200 generates replacement encryption keys by instruction from the replacement key manager function 210 and forwards the generated replacement encryption keys to network system devices, including attached functions. Each replacement encryption key generator 200 is preferably a random or pseudo-random number generator of the type known to those skilled in the art; however, in the process of generating replacement encryption keys, it preferably avoids repeating sequences and to avoid any known weak keys with respect to existing encryption algorithms.

The replacement key manager function 210 implements replacement key generation by the generator 200 by instruction to the generator 200 based on information. The key manager function 210 includes at least an analysis function to analyze network information to determine whether that information includes one or more conditions, events, occurrences, etc. (“triggers”) for the purpose of implementing one or more encryption key replacements. The replacement key manager function 210 further includes an implementation function to signal to specific replacement encryption key generators 200 to proceed with generation and key forwarding.

Continuing with reference to FIG. 1, an attached function is external to infrastructure 101 and forms part of network system 100. Examples of attached functions 104a-104e are represented in FIG. 1, and may be any of the types of attached functions previously identified. Network infrastructure entry devices 105a-b, 140, and 160 of infrastructure 101 provide the means by which the attached functions connect or attach to the infrastructure 101. Alternative entry means may be used as noted in the following paragraph. A network entry device can include and/or be associated with a wireless access point 150. For wireless connection of an attached function to the infrastructure 101, the wireless access point 150 can be an individual device external or internal to the network entry device 105b. For the purpose of illustrating the response system of the present invention, each of the network entry devices except phone 140 includes the replacement encryption key generator 200. It is to be noted that a phone may include a replacement encryption key generator; however, that is not shown in FIG. 1. The network system 100 may include other network devices without a replacement encryption key generator 200. One or more centralized network infrastructure devices may include a replacement encryption key generator 200. Further, there may be a combination of network entry and centralized forwarding devices having the replacement encryption key generator 200 of the present invention. It is also to be noted that a replacement encryption key generator 200 may be included as part of one or more attached functions.

One or more central forwarding devices, represented by central switching device 106, enable the interconnection of a plurality of network entry devices, such as devices 105a-b and 160, as well as access to network services, such as administration server 103 or an application server 107. It is to be understood that a central forwarding device, or an entry forwarding device, is not limited only to switches as that term is traditionally understood. Instead, the forwarding device may be any device capable of forwarding signals through the network infrastructure pursuant to forwarding protocols. The central switching device 106 enables the interconnection of the network infrastructure 101 to attached functions that include VPNs (represented by VPN gateway device 120) and WANs (represented by internet cloud 130) as well as Internet Protocol (IP) telephones (represented by telephone 140). It is to be understood that the IP telephone 140 may also perform as a network entry device for the purpose of connecting an attached function, such as a laptop computer, to the network infrastructure 101.

One or more devices of the network infrastructure 101 include the replacement encryption key generators 200 of the security enhancement system of the present invention. The replacement encryption key generator 200 may be established in hardware and/or software (e.g., a function embodied in an application executing on one or more devices of the network infrastructure 101) to implement replacement encryption key generation. The particular network device on which the replacement encryption key generator 200 resides may vary from manufacturer to manufacturer. A network device may also be a port or set of ports, an interface or a set of interfaces.

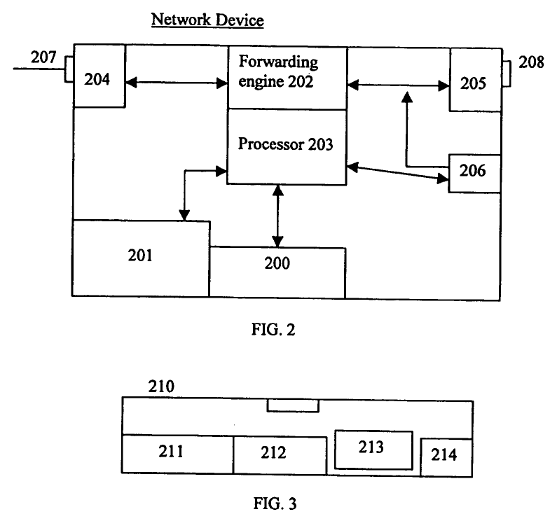

As illustrated in FIGS. 2 and 3, the security enhancement system of the present invention includes several functions and elements as briefly described above. It is to be noted that all functions and elements may be embodied in one or more devices of the network 100. However, the replacement encryption generator 200 of FIG. 2 will preferably be embodied in one or more devices of the network infrastructure 101 including, for example, the network entry device 105a, the centralized switching device 106, or the network transmission device 170. The key manager function 210 of FIG. 3 may be embodied in one or more devices of the network infrastructure 101 including, for example, the administration server 103, or the centralized switching device 106. However, it is to be noted that there may be a plurality of devices including the key manager function 210, each configured to initiate replacement encryption key generation and distribution for one or more network system devices.

A network device including the replacement encryption key generator 200 preferably also includes storage means 201, such as a database or a caching function, for storing replacement encryption key information and information regarding one or more attached functions associated with the particular network device to which such keys are distributed. The storage means 201 may be updated periodically or as a result of an event occurring anywhere in the network infrastructure 101. The storage means 201 may be a single database comprised of one or more updateable tables of information. A network device having forwarding functionality and with the replacement encryption key generator 200 includes a forwarding engine 202, a processor 203, an ingress port interface 204, an egress port interface 205, and a communication function 206.

As shown in FIG. 3, the key manager function 210 includes an analysis function 211, an implementation function 212, and a database 213. The key manager function 210 further includes a communication function 214 including means for receiving network information. Further, the key manager function 210 may receive through the communication function 214 trigger information from any means, including, for example, any network device, attached function, human operator, or administrator, to initiate the analysis and/or replacement encryption key generator 200 operation. The communication function 214 also includes means for the key manager function 210 to exchange messages with one or more network system devices, preferably in a secure manner, including those devices with the replacement encryption key generator 200. The communication function 214 may provide one or more connections to one or more network system devices having the capability to implement replacement encryption key generation, to detect intrusions and report detected intrusions to other devices of the network infrastructure 101, or a combination of both.

The database 213 of the key manager function 210 preferably includes network information of use in determining whether, where, and/or when to implement replacement encryption key generation. The information may be any type deemed by the network administrator suitable for triggering the generation of encryption key replacement at one or more network system devices including, but not limited to, the number of encrypted messages, path of data flow, endpoint locations, volume of information exchanged, protocol changes, history based information and other defined triggering events in the network. The information may be generated by the administration server 103, some other sort of centralized network infrastructure device, or from a peer, and stored in the database 213. The information is preferably stored or cached in the database 213 in advance and is not solely supplied in reaction to a triggering condition or event that may be occurring on that particular network system device. The database 213 may further include, for example, means for finding replacement encryption key generators 200, historical information, key-to-implementation device mapping, and the like. The information of storage means 201 may also be stored in database 213 of key manager function 210. Database 213 may contain the information of other key manager functions and/or for network system devices not directly commanded by a particular replacement encryption key generator 200.

With continuing reference to FIGS. 2 and 3, the analysis function 211 performs the function of evaluating network information, determining whether the information includes one or more triggers requiring initiation of the replacement of one or more encryption keys. The analysis function 201 then notifies the implementation function 212 that a replacement must be performed, and it may notify the implementation function 212 which one or more network system devices should implement the replacement. Alternatively, the implementation function 212 may perform that function. The implementation function 212 then instructs one or more identified replacement encryption key generators 200 to implement an encryption key generation operation and distribution to one or more network system devices, which may include one or more attached functions or network system devices. That instruction is directed to the processor 203 to initiate the replacement. That signaling may be achieved as through communication using unicast, multicast, and/or broadcast communication methods, but not limited thereto.

As noted, the generated replacement encryption key or keys may be distributed by unicast, multicast, or broadcast distribution including, for example a Layer 2 or Layer 3 multicast protocol distribution. In general, in a forwarding situation, the processor 203 provisions the forwarding engine 202 with the generated replacement encryption keys. Replacement keys may be generated and distributed one at a time or in sets. One or more original encryption keys may be replaced while others are retained. One or more replacement keys may themselves be replaced while others are retained. The generated replacement encryption keys may be associated with signal type, one or more transmission protocols, or one or more sets of protocols. There may be transmit encryption keys and receive encryption keys. The one or more replacement encryption keys may encrypt a portion or all of a particular message or protocol. The replacement encryption key generator 200 may generate replacement encryption keys only or it may generate replacement encryption keys and original encryption keys. The basis for distributing replacement keys may be incremental, random, pseudo-random, or as a product of a mathematical method. Further, the basis for replacing replacement encryption keys may be the same as the basis for distributing the first set of replacement encryption keys. Alternatively, the second and subsequent sets of one or more replacement encryption keys may be distributed for a reason different than the first reason or basis for replacing. In this alternative form, unauthorized data recovery would likely be more difficult as patterning is less likely to occur.

Referring back to FIG. 1, an attached function such as a service 104a attaches to infrastructure 101 through connection point 102b (e.g., a jack in a wall). Network infrastructure entry devices 105a-b and central switching device 106 connect to each other using cables and connection points in a similar manner. A connection port is the physical port through which a network client communicates. Referring to FIG. 2, the network system device includes ingress port 207 and an egress port 208. The network system device is configured at ingress port interface 204 to recognize and exchange signals with the attached function and/or other network system devices. The signals pass from the ingress port interface 204 to the forwarding engine 202 for forwarding decisions. Forwarding decisions include, but are not limited to, forwarding through egress port interface 205 received signals to other network infrastructure devices, such as the administration server 103, the application server 107, and the central switching device 106. If authentication is an aspect of the signal exchange or session to be secured by the present invention, an authentication server may also be involved in the initial setup of the session. The forwarding engine 202 may be any type of forwarding function including, but not limited to, a Layer 2 switch or bridge or a Layer 3 router. The processor 203 communicates with the forwarding engine 202, the database 201, and, via the egress port interface 205, the key manager function 210. One or more of the described interfaces, functions, forwarding engine, and processor may be discrete components, or parts of one or more common components. They may be coupled together as module components in any combination of hardware, firmware, software, microcode or any combination thereof.

Entry to the network system 100, and the infrastructure 101 primarily, may be initially regulated using authentication systems such as Network Operating Systems (NOSs), Remote Authentication Dial-In User Service (RADIUS), described in IETF RFC 2865 and IEEE 802.1X standard, which provides for port-based network entry control based on a MAC identifier. In the case of NOS and RADIUS, an authentication server provides the mechanism for establishing such authentication. RADIUS may also provide authorization and, optionally, accounting capability related to network usage. In the case of IEEE 802.1X, the network entry devices may be configured with such authentication capability, as described more fully in that standard. IEEE 802.1Q standard provides another means for controlling usage of a network. That standard is directed to the establishment and operation of VLANs. The IEEE 802.1Q standard defines the configuration of network devices to permit packet reception at a configured port entry module. Firewalls also provide a technique for network entry regulation based on their packet analysis functionality previously described. The present invention also contemplates signal exchange protection using the replacement encryption key generator 200 for exchanges that have already been authenticated, or that are not required to be authenticated.

The following is a list of a few possible devices (but not limited to only those devices) that can contain the replacement encryption key generator 200, the key manager function 210, and/or any one or more of the corresponding functions described herein: network switches, data switches, routers, WAN devices, MAN devices, optical switches, firewalls, gateways including VPN gateways and other transmission devices, computing devices such as network file servers or dedicated usage servers, management stations, Private Exchange Branch (PBX) devices, telecommunication devices, cellular phones, network connected voice over IP/voice over data systems such as hybrid PBXs and VoIP call managers, network layer address configuration/system configuration servers such as enhanced DHCP servers, enhanced Bootstrap Protocol (bootp) servers, IPv6 address auto-discovery enabled routers, and network based authentication servers providing services such as RADIUS, Extensible Authentication Protocol/IEEE 802.1X or others. It is to be noted that the present invention is applicable to telephone as well data communication network systems.

One means to provide the network information to the storage means 201 and database 213 is the Simple Network Management Protocol (SNMP). A network administrator provisions the information through the terminus of a network cable associated with the attached function. The forwarding engine 202 or other enforcement function reads the terminus information via the SNMP. In another example, SNMP MIB parameters may be established or used to obtain and configure the storage means 201 and database 213 with the desired information. MIBs may also be employed to populate one or more tables of the network system device operating as generation and/or distribution devices with historical information for storage and/or caching.

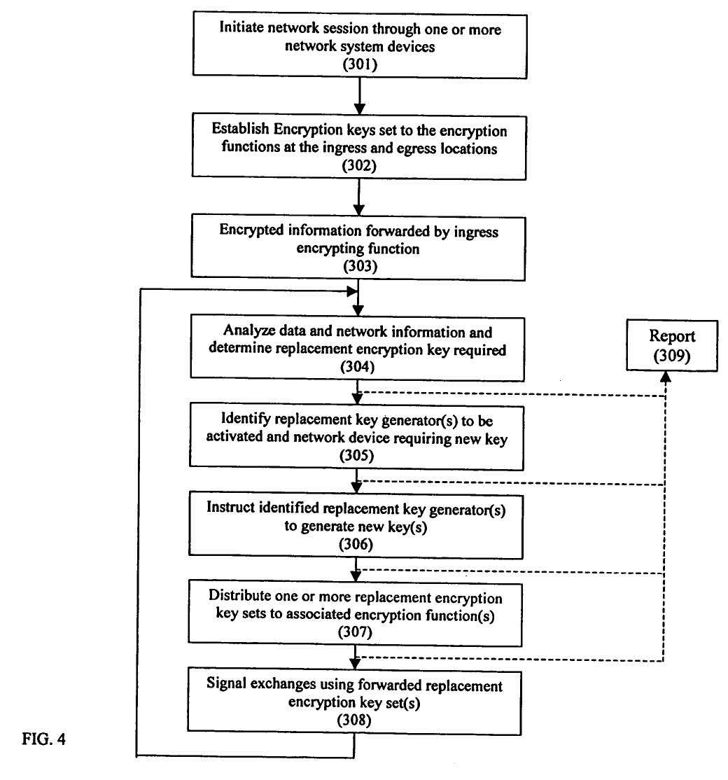

A first embodiment of the security enhancement method of the present invention for a session involving either or both of one or more attached functions and one or more network devices for which authentication may or may not be required, is shown in FIG. 4. The method represented in FIG. 4 includes initial steps generally applicable in the context of existing standards-based protocols. First, a network session is initiated through one or more network system devices (step 301). That initiation may or may not require a step of authentication. The initiation may occur through any well known means, whether in unicast, multicast, or broadcast transmission mode. The session may be initiated in any wired or wireless environment including, for example, in a cable-based physical connection, a radio frequency connection, a VPN connection, an infrared connection, a tunneled/endpoint connection, or a shared connection, such as Resilient Packet Ring (RPR), broadband, Passive Optical Network (PON), or Ethernet over First Mile (EFM). First one or more encryption key sets are established at the functions, whether attached functions, network devices, or both for use in securing messages passing to the ingress locations thereof and from the egress locations thereof (step 302). These keys are randomly or pseudo-randomly derived and secured by encryption techniques well known to those skilled in the art including, for example by RC4 by RSA labs, the Data Encryption Standard (DES), triple DES (3DES) or the Advanced Encryption Standard (AES). Optionally, each key set is marked, one as a receive key set and the other as a transmit key set. It is to be understood that for a plurality of attached functions or other network system devices, either of which type may be referred to as an encryption function, each may each receive a unique key set of one or more keys, or a portion or all of those encryption functions may share the same key set. The signal exchange session then proceeds with encrypted signals forwarded by the encryption functions, and forwarded encrypted messages de-crypted by encryption functions having the applicable encryption key set information (step 303).

With continuing reference to FIG. 4, the manager function 210 analyzes received network information and determines whether one or more replacement encryption key sets are to be generated and distributed (step 304). The information that would cause a replacement may be of any type of interest to the network administrator including, for example, signal traffic conditions, protocols, and any others deemed to be of interest. Upon determination that one or more replacement encryption key sets are to be generated and distributed, the key manager function 210 identifies one or more replacement encryption key generators 200 to be activated and one or more network system devices to carry out the replacement (step 305). Instructions are then sent to the identified one or more replacement encryption key generators 200 to generate randomly or pseudo-randomly one or more replacement encryption key sets (step 306). The generated one or more replacement encryption key sets are then distributed to one or more encryption functions (step 307). The distributed replacement encryption key set(s) is/are then employed in encrypting and decrypting signals, including protocols (step 308). The signal exchange and network information analysis are preferably substantially continuous throughout a network session. Optionally, information derived from the network system analysis, the replacement encryption key generation, and the identified of replacement encryption key generators and relevant network system devices may be reported to a reporting function (step 309).

For any particular attached function, a received encryption key set is preferably stored in a register and accessed as required to encrypt or decrypt a message. In the event a plurality of key sets is already registered, the least recently used or oldest set may be overwritten when a replacement encryption key set is generated and received. In a shared key set environment, the network entry device confirms that all attached functions return a message using the most recent key set, which may include one or more replacement encryption keys. Alternatively, the network entry device may use a fixed number of duplicate key messages, i.e., retries, in the absence of positive acknowledgement from any one or more attached functions that the key messages have been received and processed. Once all relevant attached functions clients are on the correct key set, signal exchanges are continued.

An important aspect of the present invention is that the key sets, whether randomly generated or not, are changed over the course of any signal exchange session. Current crypto analysis attacks indicate that static keys can often be recovered. For that reason, the present invention includes the replacement of an existing key set with a replacement key set, preferably based on information that ensures the replacement occurs faster than an analysis attack is able to discover the key set in use.

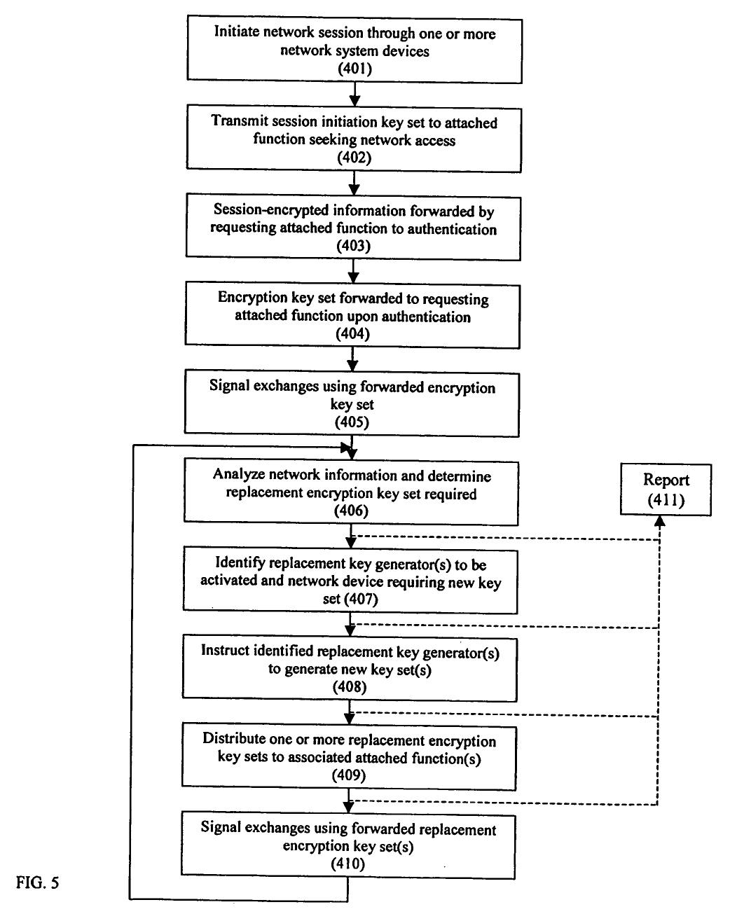

A second embodiment of the security enhancement method of the present invention for a network session involving an attached function requiring authentication, is shown in FIG. 5. The method represented in FIG. 5 includes initial steps generally applicable in the context of existing standards-based protocols. Specifically, the attached function initiates a network session through a network entry device under a suitable session initiation process, such as the EAP/TLS/802.1X protocol in a wireless setting, or other protocols in a wired setting (step 401). An authentication server addresses the initiation request by sending an initial session initiation key set to the attached function through the network entry device (step 402), it being understood that the attached function may instead be a network device, such as in the case of a point-to-point exchange within a network system. The attached function then sends session-encrypted user information to the authentication server for authentication (step 403). Assuming the authentication occurs, the network entry device transmits to the requesting attached function one or more encryption keys and unblocks a port of the device to enable signal exchange pursuant to one or more defined policies (step 404). These keys are pseudo-randomly derived and secured by encryption, using the initial session keys shared with the client. The authentication server or the key manager function 210 sends the session keys and the initial one or more encryption keys to the network entry device as part of the authentication acceptance message. Typically, each key set is marked, one as a client receive key set and the other as a client transmit key set. It is to be understood that a plurality of attached functions or other network system devices associated with a particular network device may each receive a unique key set of one or more keys, or a portion or all of those attached functions may share the same key set. Assuming shared key sets are used, the network entry device enables network system exchanges for a plurality of attached functions using the same initial assigned encryption key set (step 405).

With continuing reference to FIG. 4, the key manager function 210 analyzes received network information and determines whether one or more replacement encryption key sets are to be generated and distributed (step 406). The information that would cause a replacement may be of any type of interest to the network administrator including, for example, periodic or sporadic time, signal traffic conditions, protocols, and any others deemed to be of interest. Upon determination that one or more replacement encryption key sets are to be generated and distributed, the key manager function 210 identifies one or more replacement encryption key generators 200 to be activated and one or more network system devices to carry out the replacement (step 407). Instructions are then sent to the identified one or more replacement encryption key generators 200 to generate randomly or pseudo-randomly one or more replacement encryption key sets (step 408). The generated one or more replacement encryption key sets are then distributed to one or more attached functions (step 409). The distributed replacement encryption key set(s) is/are then employed in encrypting and decrypting signals, including protocols (step 410). The signal exchange and network information analysis are preferably substantially continuous throughout a network session. Optionally, information derived from the network system analysis, the replacement encryption key generation, and the identified of replacement encryption key generators and relevant network system devices may be reported to a reporting function (step 411).

For any particular attached function, a received encryption key set is preferably stored in a register and accessed as required to encrypt or decrypt a message. In the event a plurality of key sets is already registered, the least recently used or oldest set may be overwritten when a replacement encryption key set is generated and received. In a shared key set environment, the network entry device confirms that all attached functions return a message using the most recent key set, which may include one or more replacement encryption keys. Alternatively, the network entry device may use a fixed number of duplicate key messages, i.e., retries, in the absence of positive acknowledgement from any one or more attached functions that the key messages have been received and processed. Once all relevant attached functions clients are on the correct key set, signal exchanges are continued.

An important aspect of the present invention is that the key sets, whether randomly generated or not, are changed over the course of any signal exchange session. Current crypto analysis attacks indicate that static keys can sometimes be detected. For that reason, the present invention includes the replacement of an existing key set with a replacement key set, preferably based on information that ensures the replacement occurs faster than an analysis attack is able to discover the key set in use.

It is to be understood that the functions described herein may be implemented in hardware and/or software. For example, particular software, firmware, or microcode functions executing on the network infrastructure devices can provide the implementation function. Alternatively, or in addition, hardware modules, such as programmable arrays, can be used in the devices to provide some or all of those capabilities.

Other variations of the above examples may be implemented. One example variation is that the illustrated processes may include additional steps. Further, the order of the steps illustrated as part of the process is not limited to the order illustrated in FIGS. 4 and 5, as the steps may be performed in other orders, and one or more steps may be performed in series or in parallel to one or more other steps, or parts thereof.

The processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of system 100 described above and may be distributed across one or more such components.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A method for enhancing the security of a network having one or more network devices including one or more network infrastructure devices capable of exchanging messages, the method comprising the steps of:
a. generating a plurality of encryption keys;
b. encrypting some or all of the messages exchanged between two or more of the network infrastructure devices, or exchanged within one or more of the network infrastructure devices, with one or more of the plurality of encryption keys; and
c. in the course of the message exchanges, replacing one or more of the one or more encryption keys with one or more replacement encryption keys.

2. The method of claim 1 wherein at least one of the plurality of encryption keys is designated for transmission selected from the group consisting of multicast transmissions, for broadcast transmissions, and unicast transmissions.

3. The method of claim 1 wherein some or all of the plurality of encryption keys are replaced as a function of the number of encrypted messages, randomly, or the amount of information exchanged during the message exchanges.

4. The method of claim 1 wherein at least one of the one or more network infrastructure devices is selected from the group consisting of wireless access points, routers, VPN gateways, and switches.

5. The method of claim 1 wherein the plurality of encryption keys are randomly generated.

6. The method of claim 1 wherein the one or more replacement encryption keys are randomly generated.

7. The method of claim 1 wherein the encryption keys are protocol encryption keys.

8. The method of claim 1 further comprising the step of replacing one or more of the one or more replacement encryption keys.

9. The method of claim 8 wherein the step of replacing one or more of the one or more replacement keys is performed on a basis that is different from the basis for first replacing the one or more plurality of encryption keys, wherein the basis for replacement is selected from the group consisting of incremental replacement, random replacement, pseudo-random replacement, and mathematical algorithm replacement.

10. The method of claim 1 wherein the messages are exchanged across a transmission medium selected from the group consisting of wired, radio frequency, WAN, VPN, infrared, RPR ring, PON, and Ethernet over First Mile.

11. A method for enhancing the security of a network including one or more network devices capable of providing access to the network for one or more attached functions, the method comprising the steps of:
a. generating a plurality of encryption keys for use in encrypting message exchanges between the one or more attached functions and the network;
b. using the plurality of encryption keys in the message exchanges between the one or more network access devices and the one or more attached functions;
c. generating one or more replacement encryption keys; and
d. during the session, replacing one or more of the plurality of encryption keys with the one or more replacement encryption keys at non-regular intervals.

12. The method of claim 11 wherein the plurality of encryption keys and the one or more replacement encryption keys are randomly generated.

13. The method of claim 11 wherein at least one of the one or more network access devices generates and transmits the plurality of encryption keys and the one or more replacement encryption keys.

14. The method of claim 11 wherein at least two of the plurality of encryption keys is unique to each attached function.

15. The method of claim 11 wherein some or all of the plurality of encryption keys are replaced as a function of the number of encrypted messages, randomly, or as a function of the amount of information exchanged.

16. The method of claim 11 further comprising the step of replacing one or more of the one or more replacement encryption keys.

17. The method of claim 16 wherein the step of replacing one or more of the one or more replacement keys is performed on a basis that is different from the basis for first replacing the one or more plurality of encryption keys, wherein the basis for replacement is selected from the group consisting of incremental replacement, random replacement, pseudo-random replacement, and mathematical algorithm replacement.

18. The method of claim 11 wherein at least one of the plurality of encryption keys is designated for multicast transmissions or broadcast transmissions.

19. The method of claim 11 wherein at least one of the plurality of encryption keys is associated with a transmission protocol.

20. The method of claim 11 wherein at least one of the plurality of encryption keys is associated with a set of transmission protocols.

21. The method of claim 11 wherein at least one of the plurality of encryption keys is a retained encryption key that is not replaced when others of the plurality of encryption keys are replaced.

22. A method for enhancing the security of a network including one or more network devices capable of providing access to the network, the method comprising the steps of:
a. generating a plurality of encryption keys for use in encrypting messages between the one or more network access devices and one or more attached functions;
b. encrypting some or all of the messages with one or more of the plurality of encryption keys; and
c. in the course of exchanging messages with the one or more attached functions, without authenticating, transmitting to the one or more attached functions one or more replacement encryption keys to replace one or more of the one or more encryption keys.

23. The method of claim 22 wherein the plurality of encryption keys and the one or more replacement encryption keys are randomly generated.

24. The method of claim 22 wherein at least one of the one or more network devices generates the one or more encryption keys and the one or more replacement encryption keys.

25. The method of claim 22 wherein at least one of the attached functions is selected from the group consisting of an internet interface function, a VPN interface function, and a wireless interface function.

26. The method of claim 22 wherein some or all of the plurality of encryption keys are replaced as a function of the number of encrypted messages, randomly, or as a function of the amount of information exchanged during the message exchanges.

27. The method of claim 22 further comprising the step of replacing one or more of the one or more replacement encryption keys.

28. The method of claim 27 wherein the step of replacing one or more of the one or more replacement keys is performed on a basis that is different from the basis for first replacing the one or more plurality of encryption keys, wherein the basis for replacement is selected from the group consisting of incremental replacement, random replacement, pseudo-random replacement, and mathematical algorithm replacement.
